(19) United States
(12) Patent Application Publication
(10) Pub. No.: US 2019/0027949 A1
(43) Pub. Date: Jan. 24, 2019

(54) PORTABLE POWER BANK FOR A SMARTWATCH OR THE LIKE

(71) Applicant: Claudio CRITELLI, ROMA (IT)

(72) Inventor: Claudio CRITELLI, ROMA (IT)

(21) Appl. No.: 16/071,526

(22) PCT Filed: Jan. 16, 2017
(86) PCT No.: PCT/IB2017/050223

§ 371 Date: Jul. 20, 2018

(30) Foreign Application Priority Data
Jan. 20, 2016 (IT) 202016000004753

(51) Int. Cl. H02J 7/00; H02J 50/10; G04G 19/00

(52) U.S. Cl. CPC H02J 7/0054; H02J 7/0044; H02J 2007/0062; G04G 19/00; H02J 50/10

(57) ABSTRACT

The present invention provides a portable power bank (1), comprising a prismatic body (2) having a surface on which it is formed a magnetic inductive charging region (3), and it is characterized in that it further comprises supporting means (4) for supporting a smartwatch (10) electronic device type or the like, said supporting means (4) being integrally formed on the surface of said prismatic body (2) and such that said support means (4) provides the locked supporting of said smartwatch electronic device type (10) or similar onto said portable power bank (1).

The present invention relates to a device for recharging known as “power bank” for the recharging of electronic devices via wireless or through electromagnetic induction and, more precisely, to a portable “power bank” which allows the user to recharge electronic devices via electromagnetic induction, and the carrying thereof during the charging while said devices are coupled to said power bank.

The present invention it is particularly directed to the use thereof with a smartwatch.

### STATE OF THE ART

To date are widely known the so-called “power bank” as charging devices to provide electric power to electronic devices while on the move and far from a fixed charging point.

Typically, such power banks are constituted by one or more accumulators accommodated within an enclosure and suitable to be charged through a USB cable from a power source, such as a laptop computer or a wall charger. Once the accumulators are charged, the Power Bank can provide power to any electronic device (i.e., smartphone, smartwatch, tablets, cameras, camcorders, etc.) through for example, a USB connection.

On the other hand, it is more and more present in the market of wearable electronic devices (wearable technology) the so-called “smartwatch”. As it is known, a “smartwatch” is a clock that has several additional features to the simple clock function, and typically these additional functions are those which are normally provided in a “smartphone” (last generation mobile phone). A smartwatch it is in fact a peripheral device that functions as an extension of a smartphone display while the latter is being carried.

Further, such smartwatch in order to function with the totality of functions it must interface with a smartphone carried by the user, and via a Bluetooth connection.

Moreover, there are already many of smartwatch models having different sizes and shapes for what concerns the dial, the straps, power of the battery, etc. and which interface with different operating systems, typically both iOS and Android.

On the other hand, given the nature of the smartwatch device, the same it is charged via magnetic induction (i.e. wireless). Wireless charging, also known with the technical term “inductive charging”, it is a technology recently introduced in many new smartphone and smartwatch and which allows the recharging the terminal device without a direct connection via a cable but via electromagnetic fields generated by a second device, usually a wireless charging base. The base it is connected to the power supply, and provides a surface onto which the device can be placed on the back side thereof. The contact between the base and smartphone (or smartwatch or similar product) leads the energy coming from the wall outlet directly to the battery of the portable electronic device via electromagnetism. In this way and without using any wire connected through the docking station, the smartphone or the smartwatch it is recharged.

A first disadvantage of the presents solution consists of a wireless charging of the device but not on the move. In fact, for the inductive charging the electronic device to be charged must be exclusively placed or resting in contact with the bas, and therefore the same does not allow the user to recharge the device in mobility.

Another disadvantage resides in the fact that most of the charging bases in order to function they must be connected to a power source. In fact, typically the charging bases have to be placed onto a desk or onto a work table and close to said power supply.

On the other hand, the movable “power bank” charging base are known, i.e. charging bases internally equipped with accumulators and which to function do not need to be electrically connected to a power supply network. However, this type of charging base does not allow the user to charge the electronic device in mobility, since it must be put on a surface and the device to be charged must be statically positioned onto the same.

### BRIEF DESCRIPTION OF THE INVENTION

The object of the present invention it is to solve the aforesaid disadvantages by providing a device for charging electronic devices using magnetic induction in mobility, i.e. being able to perform the charging of the electronic device via magnetic induction even if the user is in motion.

Another object of the present invention is to provide a device for charging electronic devices using magnetic induction in mobility that is of reduced sizes such as to be easily carried by a user in a pocket or the like during its use.

A further object of the present invention is to provide a device for charging electronic devices using magnetic induction in mobility that is extremely compact and sturdy, reliable, easy to manufacture and of low cost.

Therefore, the present invention provides a portable device for charging electronic devices via magnetic induction substantially according to annexed claims.

### DETAILED DESCRIPTION OF THE INVENTION

A detailed description of two preferred embodiments of the device for the charging of electronic devices via magnetic induction during the mobility of the user will be now given and according to the present invention, given by way of a non-limiting example and with reference to the accompanying figures, in which:

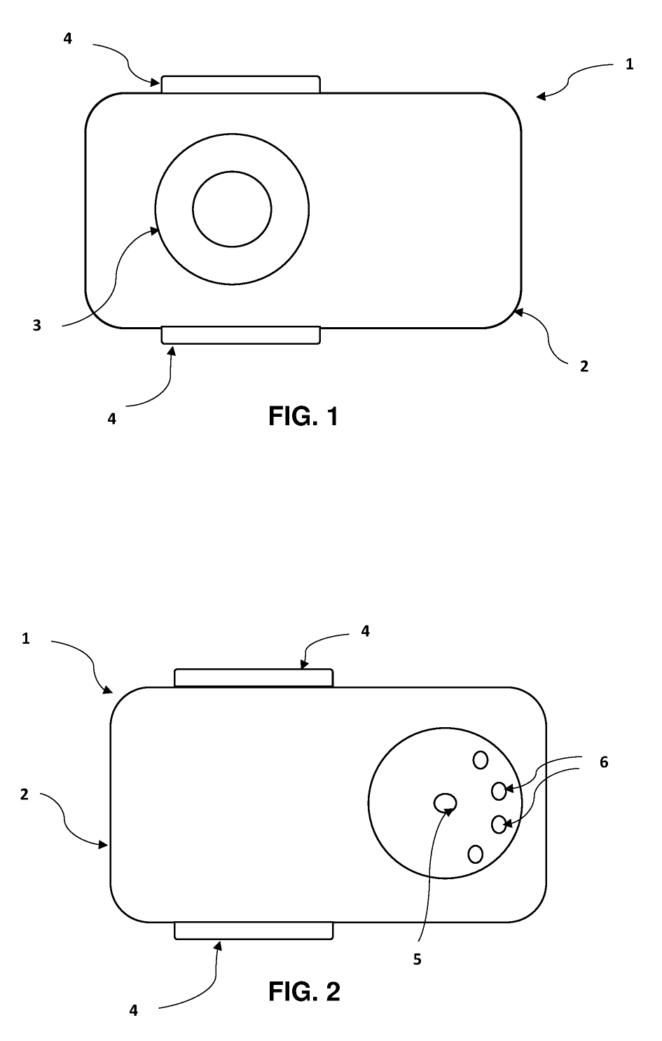

FIG. 1 is a schematic top plan view of the device of the present invention according to a first embodiment thereof;

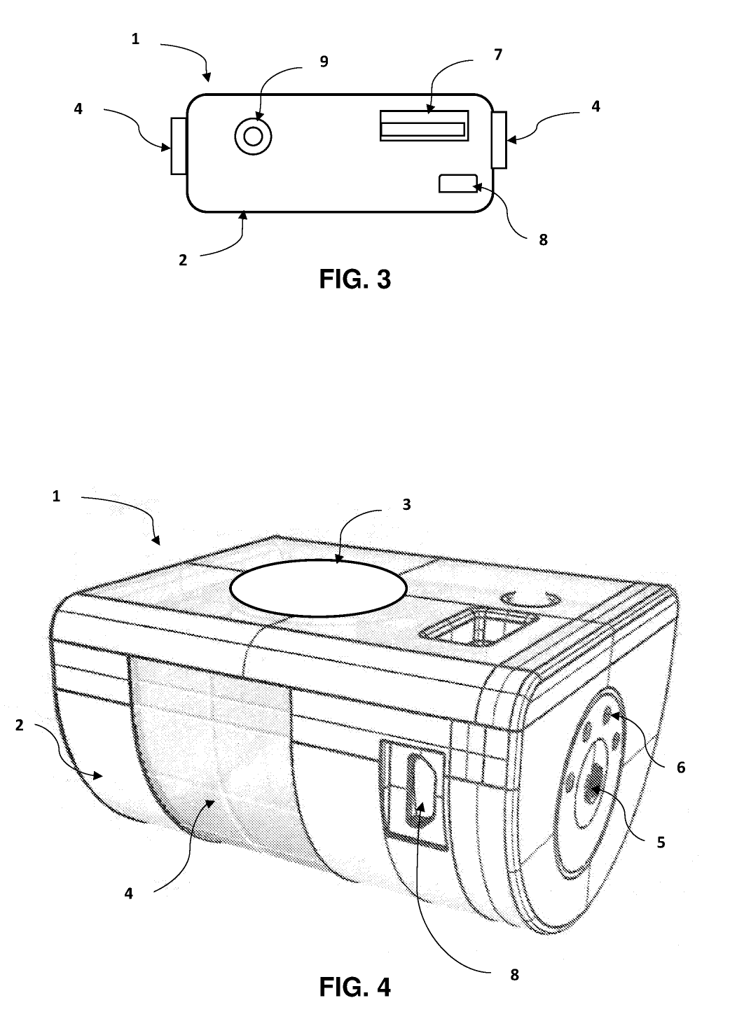

FIG. 2 is a schematic bottom plan view of the device of FIG. 1 and according to the present invention;

FIG. 3 is a schematic elevational view from one side of the device of FIG. 1 and according to the present invention;

FIG. 4 is a schematic perspective view from one side and from above of the device of the present invention according to a second embodiment thereof; and

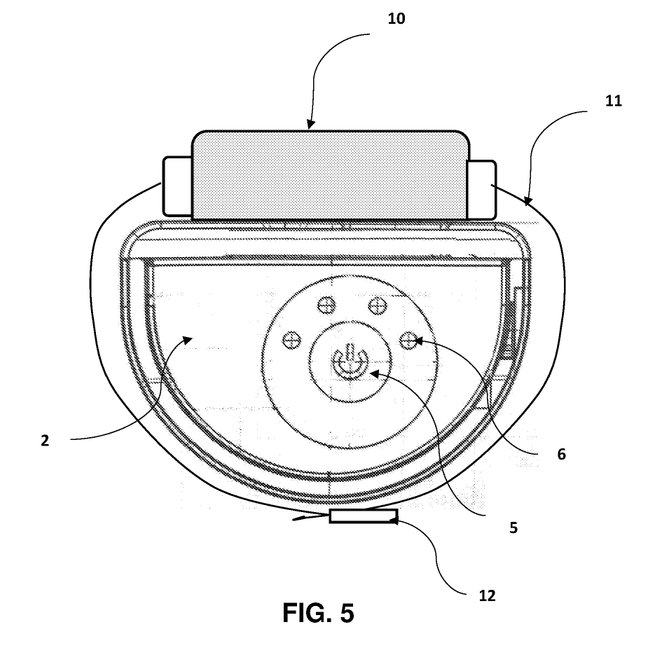

FIG. 5 is a schematic elevational view from one side of the device of FIG. 4 and according to the present invention.

With reference now to FIG. 1, therein it is illustrated a first embodiment of the charging device of the present invention. For the sake of clarity from now on reference will be made to the charging device with the term “power bank”.

The power bank 1 has a body 2 substantially parallelepiped shaped (better illustrated hereinafter). On one surface thereof it has a region 3 which is coplanar to the surface and which internally accommodates a magnetic inductive charging device compatible with the respective magnetic induction device on the electronic device to be charged (the latter not being illustrated in the figure). The design and functioning of a magnetic induction device being already known to the men skilled in the art, will not here be described in detail. Therefore, the region 3 interfaces by surface contact with the respective electronic device to be charged.

Further, on the two opposite surfaces of the body 2 and in a position which corresponds to the region 3 there are integrally formed supporting means 4 for supporting a smartwatch device (the latter not shown). The supporting means consists of protruding elements 4 which create a supporting region for a smartwatch strap or similar. More precisely, the arrangement of the supporting means 4 is such that when the smartwatch is positioned onto the charging region 3, the supporting means 4 provide a supporting region to the smartwatch strap, and such that the strap can be wrapped around to the body 2 of the power bank 1, and fixed thereto (better illustrated hereinafter).

With reference now to FIG. 2, therein it is illustrated the power bank 1 from the opposite side to the side where a smartwatch it is interfaced for charging. On this side there is a region that contains a switch 5 for switching on/off the power bank 1. Moreover, there are provided a plurality of LED 6 for showing the status of the charging power bank 1.

With reference now to FIG. 3, therein is illustrated the power bank 1 in elevation and from one side. On this side there is provided a USB socket 7 for interfacing the power bank 1 with an electronic device via a USB cable (not shown in the figure). In addition, a mini USB socket 8 is typically provided to power/charge the power bank 1 via the provided cable to an external power network. Furthermore, a LED illuminator 9 it is provided to provide to the user a light/torch source function in a manner already known.

With reference now to FIGS. 4 and 5 it is therein illustrated a second embodiment of the power bank of the present invention. For the sake of clarity, same parts will have the same numbers and the detailed description thereof will be here omitted because already provided.

According to the present embodiment, the power bank 1 has a body 2 which has a substantially semi-cylindrical shape incorporating a flat surface and a convex surface, the shape of the body resulting as the vertical development of a prism having with a “D” shaped plant. On the flat surface there is provided a charging region 3 which is coplanar to the surface and which internally accommodates a magnetic inductive charging device compatible with a respective magnetic induction device housed onto the electronic device to be recharged (the latter not being illustrated in the figure). The region 3 interfaces by surface contacting with the respective electronic device to be charged (not shown in the figure).

Further, onto the convex surface and corresponding to the charging region 3 there are integrally obtained the supporting means 4 for supporting a smartwatch type device (the latter not shown in the figure). According to this second embodiment, as a supporting means there is provided a recessed region 4 with respect to the convex surface, and such that the recessed region 4 it is designed to accommodate a strap 11 of a smartwatch 10 or the like (better illustrated hereinafter).

More precisely, and with particular reference to FIG. 5, the arrangement of the region 4 is such that when the smartwatch 10 is placed onto the charging region 3 to perform recharging, the recessed region 4 provides a supporting housing to the strap 11 of the smartwatch 10, and such that the strap 11 can be wrapped around the body 2 of the power bank 1, and fixed thereto by means of the buckle 12, thus blocking the smartwatch 10 in position and preventing the detachment/moving thereof from the charging region 3 during the charging.

On the other hand, on one side of the body there are comprised the main switch 5 for turning on/off the power bank 1. Moreover, there are comprised a plurality of LED 6 for showing the status of charge of the power bank 1. Further and referring to FIG. 4, on the convex surface there is provided a mini-USB socket 8 to power the power bank 1 via its cable from an external power network.

### ADVANTAGES

The power bank 1 of the present invention has a number of advantages.

A first advantage is given by the fact that according to the constructive arrangement of the power bank 1 it allows to the user the charging of a smartwatch 10 blocked onto the former during the charging of the latter, and thus making the assembly transportable and portable while charging without risk of interruption of charging.

Another advantage consists in the fact that during the charging and the user mobility it is still possible to take advantage of the smartwatch 10 functions while charging.

A further advantage is given by the fact that the power bank 1 has such a configuration that may be associated to any of smartwatch 10 type on the market thereby ensuring the recharging in mobility, i.e. one shape/size of power bank 1 it is compatible with different types of smartwatch 10, guaranteeing the charging in mobility.

Another advantage is given by the fact that the constructive embodiment of the power bank 1 is such that it can function without distinction as a fixed or portable charging base.

1-13. (canceled)

14. A portable power bank (1) for charging and carrying a smartwatch electronic device (10) type or the like during the charging thereof, comprising:
a prismatic body (2) having a surface which includes a magnetic inductive charging region (3); and
supporting means region (4) for supporting said smartwatch electronic device (10) type or the like, said supporting means region (4) being integrally formed onto the surface of said prismatic body (2), said supporting means region (4) providing a locked supporting condition of said smartwatch electronic device type (10) or the like onto said portable power bank (1) during the carrying thereof.

15. The portable power bank (1) according to claim 14, wherein said prismatic body (2) has a substantially parallelepiped shape.

16. The portable power bank (1) according to claim 14, wherein said supporting means comprises protruding elements (4) which protrude from the surface of said prismatic body (2).

17. The portable power bank (1) according to claim 14, wherein said supporting means comprises protruding elements (4), said protruding elements (4) provide a supporting region for a strap (11) of said smartwatch (10) or the like, the arrangement of said protruding elements (4) is such that when said smartwatch (10) it is mounted onto said power bank (1) at said charging region (3), said protruding elements (4) support said strap (11) of said smartwatch (10) or similar, and said strap (11) being wrapped around the body (2) in a blocked condition.

18. The portable power bank (1) according claim 14, wherein:
said prismatic body (2) has a substantially parallelepiped shape;
said supporting means comprises protruding elements (4) which protrude from the surface of said prismatic body (2);
said protruding elements (4) provide a supporting region for a strap (11) of said smartwatch (10) or the like, the arrangement of said protruding elements (4) is such that when said smartwatch (10) it is mounted onto said power bank (1) at said charging region (3), said protruding elements (4) support in a firm condition said strap (11) of said smartwatch (10) or the like, and said strap (11) being wrapped around the body (2) in a locked condition;
the portable power bank (1) further comprising a region which comprises:
a main switch (5) for turning on/off of said power bank (1);
a plurality of LEDs lights (6) to indicate the status of said power bank (1);
a USB socket (7) for interfacing to said power bank (1) with an electronic device via USB cable;
a mini USB socket (8) for powering said power bank (1) via cable to an external power network; and
a LED status illuminator (9).

19. A portable power bank (1) for charging and carrying a smartwatch electronic device (10) type or the like during the charging thereof, comprising:
a prismatic body (2) having a surface which includes a magnetic inductive charging region (3); and
supporting means region (4) for supporting said smartwatch electronic device (10) type or the like, said supporting means region (4) being integrally formed onto the surface of said prismatic body (2), said supporting means region (4) providing a locked supporting condition of said smartwatch electronic device type (10) or the like onto said portable power bank (1) during the carrying thereof,
wherein said prismatic body (2) has a substantially semi-cylindrical shape which includes a first flat surface joined to a second convex surface, said semi-cylindrical shaped body resulting from the vertical development of a prism having a “D” shaped base.

20. The portable power bank (1) according to claim 19, wherein said first flat surface comprises a coplanar magnetic inductive charging region (3).

21. The portable power bank (1) according to claim 19, wherein:
said first flat surface comprises a coplanar magnetic inductive charging region (3); and
said convex surface and said charging region (3) include integrally formed supporting means (4) for supporting a smartwatch electronic type device (10) or the like.

22. The portable power bank (1) according to claim 19, wherein:
said first flat surface comprises a coplanar magnetic inductive charging region (3);
said convex surface and said charging region (3) include integrally formed supporting means (4) for supporting a smartwatch electronic type device (10) or the like; and
said supporting means comprises a supporting region (4) formed onto said convex surface, said supporting region (4) being recessed with respect to said convex surface, the arrangement being such that said supporting region (4) provides a supporting housing to a strap (11) of said smartwatch (10) or the like, and such that said strap (11) it is wrapped and locked around to said body (2) of said power bank (1).

23. The portable power bank (1) according to claim 19, wherein
said first flat surface comprises a coplanar magnetic inductive charging region (3);
said first flat surface comprises a coplanar magnetic inductive charging region (3);
said convex surface and said charging region (3) include integrally formed supporting means (4) for supporting a smartwatch electronic type device (10) or the like;
said supporting region (4) being recessed with respect to said convex surface, the arrangement being such that said supporting region (4) provides a supporting housing to a strap (11) of said smartwatch (10) or the like, and such that said strap (11) it is wrapped and locked around to said body (2) of said power bank (1);
the portable power bank (1) further comprising a region which comprises:
a main switch (5) for turning on/off of said power bank (1);
a plurality of LEDs lights (6) to indicate the status of said power bank (1);
a USB socket (7) for interfacing to said power bank (1) with an electronic device via USB cable;
a mini USB socket (8) for powering said power bank (1) via cable to an external power network; and
a LED status illuminator (9).
